(19) United States
(12) Patent Application Publication
(10) Pub. No.: US 2005/0080682 A1
(43) Pub. Date: Apr. 14, 2005

(54) System for secure distribution of electronic content and collection of fees

(76) Inventor: Eric Wilson, Victoria (AU)

Correspondence Address: SANDRA L. ETHERTON;ETHERTON LAW GROUP, LLC, PO BOX 27843, TEMPE, AZ, 85285-7843, US

(21) Appl. No.: 10/498,670

(22) PCT Filed: Dec. 10, 2002
(86) PCT No.: PCT/AU02/01667

(30) Foreign Application Priority Data
Dec. 10, 2001 (AU) PR9409

(51) Int. Cl. G06F 17/60

(52) U.S. Cl. 705/26

(57) ABSTRACT

A system and method for the secure distribution of electronic content, particularly electronic documents, using primarily remote display protocols. One or more presentation subsystems retrieve electronic content from repositories, reformat the content and render the content for display according to a users equipment and preferences. A management subsystem checks associated business models (such as fees, access limits, credit rating) to determine viewing conditions for the user of the electronic content. The system and method provide an automated secure mechanism for remote access to electronic content.

### FIELD OF THE INVENTION

The invention relates to a system for secure distribution of electronic content and a mechanism for collecting and distributing fees (royalties and usage charges) due. In particular, the invention provides a mechanism for preventing copyright infringement of electronic documents.

### BACKGROUND

Teletext services have been in commercial use for decades to display paged images of textural information to TV set-top boxes around the world. The idea was based around the notion of an online-newspaper. Teletext has the electronic advantage of updating its pages live as events unfold, with a far broader range of indexed topics on demand than traditional television news can deliver. Despite these advantages, Teletext has not become popular, lacking the richness of content types, navigability, search-ability, interactivity, variety, capacity and reach of the Internet. However as a publishing system, the Internet only came of age when the World Wide Web was invented, which embodied these characteristics into a scrolling page and hyperlink paradigm. But for many commercial publishers, the World Wide Web has been financially disastrous.

Unlike Teletext, which usually required a proprietary decoder to access, the Web distributes its information by liberally sending easily decodable content source files to proxy servers and end users alike. This allows any recipient to make unauthorized duplications. Consequently, to avoid the instant devaluation of content through unauthorized republishing via newsgroups, proxy servers, email, pirate sites and the like, publishers have kept most of the world's best content off the net, confining it to paper instead. As a result, many authors whose works have not been recognized as satisfying the economics of conventional paper publishing still remain unpublished.

A number of approaches to solving these problems have been based on the concept of allowing end-users to download an encrypted copy of the document and allowing access after a required royalty fee has been paid. Unfortunately, hackers have thwarted many of these methods by breaking into unprotected end-user program memory after the content has been decrypted. As a result, systems based on downloading encrypted files have not gained wide publisher acceptance.

Remote display protocols have been slowly developing the robustness and scalability required for the transmission of live computer screen images over the Internet to big audiences. These protocols work by maintaining the end-user's application on a server, while only sending the screen updates to an end user's display. The screen image updates take comparatively little bandwidth to transmit, easily traversing a standard dial-up modem instead of needing thick coaxial cable, as is the case with cable TV. The success of these protocols is achieved by avoiding where possible the sending of bulky pixel-for-pixel or field-by-field pictures of screens from the server to the end-user, but instead sending compact graphics commands. These are able to rapidly mirror the fonts and shapes on the end-user's display. Mouse clicks and keystrokes are sent back to the server over the same network to support end-user interaction with the live screens. Examples of industry-standard remote display protocols include Citrix ICA, Microsoft RDP and Unix-based X-11.

Though a good technology for transmitting the relatively simple gray images of applications, remote display protocols by themselves are not as good at sending complex document images over sometimes-slow networks, like the Internet. One problem is they often don't display scrolling very well, often redrawing big chunks of the screen, which then needs transmitting to the end-user's display. This problem is compounded on small-screen devices such as mobile phones, which require a lot of scrolling to faithfully present documents in unmodified form.

Additionally, delays over the Internet in getting a user's mouse-clicks back to the server and the appropriate screen update back to the user can cause several clicks to be sent in frustration ‘because nothing is happening’. This leads to over-scrolling and subsequent scrolling back again. This effect is exacerbated when the Internet is accessed over cell phone or satellite networks, which being radio-based, may introduce additional roundtrip response delays of at least a second.

Clicks for scrolling can also cause problems at the server, as significant computing power will be required to execute commands from hundreds of simultaneous remote display users on the one machine. Indeed, depending on the container application in which the document is being displayed, scrolling and navigation may be impossible to achieve satisfactorily, with the application redrawing and thus resending the entire screen several times for each mouse click, slowing the user experience down to a crawl. Thus documents designed for the Web, for printing or in device independent formats such as Adobe Acrobat files may not work well unmodified if transmitted using remote display protocols.

A significant inhibitor to the adoption of remote display protocols for Internet-style document image publishing has been cost. It takes at least an order of magnitude more processing power to support an end-user's remote graphical user interface on a server than just sending them a simple Web page. Additionally, many Web servers are downloaded free to the service provider, while remote display protocols and their operating systems, suitable for slow networks such as the Internet, are typically quite expensive. This means that commercial online publishing cannot take place using remote display protocols unless the Internet publisher's micro-payments problem is addressed. This occurs when a document is worth less to the end user than the additional cost of a credit or bank transaction charge to the publisher.

One answer has been for publishers to sell online subscriptions to a site instead of individual documents, with users consuming their deposited funds as documents are made available. This idea has three problems: firstly, every publisher must run their own secure billing and tracking system, which represents a high barrier to entry for the world's 80,000 small publishers; secondly, every publisher would need to instill trust to a security and privacy weary public, that they would not loose their money or the privacy of their credit card details; thirdly, if an end-user only wants to see one document, the rest of their subscription is wasted.

These problems could be addressed by creating a centralized cross-publisher billing and tracking system, allowing users to pay a single entity for a ‘universal subscription’. But this idea raises another round of serious technical challenges, due to the ‘live-on-line’ nature of remote display protocols.

The problems of billing and tracking live document images mainly relate to the Internet's scale. Very large remote display protocol systems within corporations may accommodate ten thousand users at once. But a magazine with this many subscribers is considered small. A newspaper site, with hundreds of thousands of readers, could easily generate this kind of traffic every time a major story breaks. Likewise, very large conventional databases used for live billing and tracking are usually only rated to ten or twenty thousand users at once. A micro-payments system is required that supports at least a million live simultaneous remote display protocol document image users. A billing and tracking system on this scale is not currently available. Furthermore a remote display protocol document image publishing system also faces the problem of producing up to the second account details for millions of people instantly on demand, tracking not an ongoing credit balance but a mixture of clear and pending funds from a variety of sources.

Prior patent documents have been identified that relate to downloadable content systems designed to support commercial online publishing. Reference may be had to three United States patents owned by Xerox Corporation.

U.S. Pat. No. 5,629,980 describes a system of storing digital works in secure repositories. Each work has associated with it the terms, conditions and fees for accessing the work. The work is not accessible by a user until the fees and conditions are satisfied. Once a user is granted access the work is transferred to a secure rendering system that includes a secure rendering repository. The security of the system relies upon the security of the repository, which is an encryption system. Once access is granted the digital work is resident on the user's system and therefore subject to decryption and copying.

U.S. Pat. No. 5,638,443 is similar to U.S. Pat. No. 5,629,980 but extends the invention to cover composite digital works that include digital video, digital music and printer-ready documents. To achieve this extension the patent defines a digital work as having a description part and a content part. The mechanism of using repositories for serving and requesting digital works is the same as described in U.S. Pat. No. 5,629,980.

The third Xerox patent, U.S. Pat. No. 5,634,012, focuses on the fee accounting mechanism of the system described in U.S. Pat. No. 5,629,980.

Xerox Corporation has approached the problem of commercial online publishing by proposing, in essence, a software photocopier. The idea appears to be for end users to use this software to reproduce content, whereby such reproductions are metered for access by authorized parties and charged for accordingly. However, the content still becomes resident on a users machine and is therefore subject to unauthorized copying if the security protocols are circumvented.

International patent application number PCT/US99/05368, in the name of Cha! Technologies Services Inc, has a number of similarities to the Xerox system. The Cha! system is directed primarily to an automatically invoked intermediation process for levying fees from network purchases. Like the Xerox approach, Cha! relies upon encryption of the digital work which is unlocked after a financial transaction is verified. As the digital work finally resides on the purchasers system, it may still be subject to unauthorized copying and distribution.

Another problem to be addressed when distributing electronic documents is the rendering of the documents for display on the users system. This problem is particularly relevant with the popularity of the WAP phone technology that allows electronic documents to be displayed on LCD screens that may be only a few centimeters wide. A number of approaches have been taken to address this issue. One such approach is described in United States Patent Application number 2001-0011364, in the name of Stroub. Stroub reformats documents into columns that have a fixed number of characters per line. The number of columns is selected to suit a given screen The approach of Stroub is useful for simple text but is of limited value for more complex content.

Another approach is described in U.S. Pat. No. 6,175,845 and U.S. Pat. No. 5,818,446, in the name of IBM Corp. The IBM approach is to implement navigation between parts of a document by inferring the significance of content to users. Content-based analysis is a particularly processor intensive mechanism for display of content that is not practical for most applications.

The prior art does not describe a system that allows for secure distribution of electronic documents and the publication of their images via remote display protocols and a mechanism for collecting and distributing fees (royalties and usage charges) due.

### OBJECT OF THE INVENTION

It is an object of the present invention to provide a system for secure distribution of electronic documents and the publication of their images.

It is a further object of the invention to provide a mechanism for collecting and distributing payment for viewing of electronic content and other forms of access to associated materials.

Further objects will be evident from the following description.

### SUMMARY OF THE INVENTION

In one form, although it need not be the only or indeed the broadest form, the invention resides in a system for secure distribution of electronic content comprising:
a management subsystem that checks business models associated with electronic content to determine one or more of viewing conditions, levying of fees and distribution of fees; and
one or more presentation subsystems that retrieve electronic content from repositories, reformat the electronic content, and render the electronic content for display by remote display protocols.

Suitably the management subsystem resides on centralized server groups but the presentation subsystem may be distributed across many distributed servers.

The system may also include an interface subsystem that provides access for users to the electronic content and indicates any fees to be levied.

Suitably the system also includes a payment subsystem that intermediates payments between fee payers, fee receivers and one or more financial institutions or organisations maintaining accounts on behalf of others.

In preference, the invention may also include one or more stakeholder subsystems that provide management functions for authors, publishers, advertisers, developers, the operators of the system and other stakeholders. Management functions include associating business models, comprising but not limited to scripts, documents and data, with electronic content. Business models are used to implement relationships between all the stakeholders and end-users. The stakeholder subsystems are suitably distributed across computers convenient to each stakeholder, and are in communication with the management subsystem.

Electronic content is preferably electronic documents but may also be video, audio, printer instructions or other digital media.

In a further form the invention resides in a method of securing electronic content including the steps of:
storing the electronic content in a repository;
associating business models with the electronic content;
receiving a request from a user to view the electronic content;
checking business models associated with the electronic content for determining fee structure information;
crediting accounts with fees according to the fee structure information; and
presenting the electronic content to the user via remote display protocols.

### BRIEF DETAILS OF THE DRAWINGS

To assist in understanding the invention preferred embodiments will now be described with reference to the following figures in which:

FIG. 1 displays an overview of the system;

FIG. 2 is an overview of the management subsystem;

FIG. 3 is an overview of the presentation subsystem;

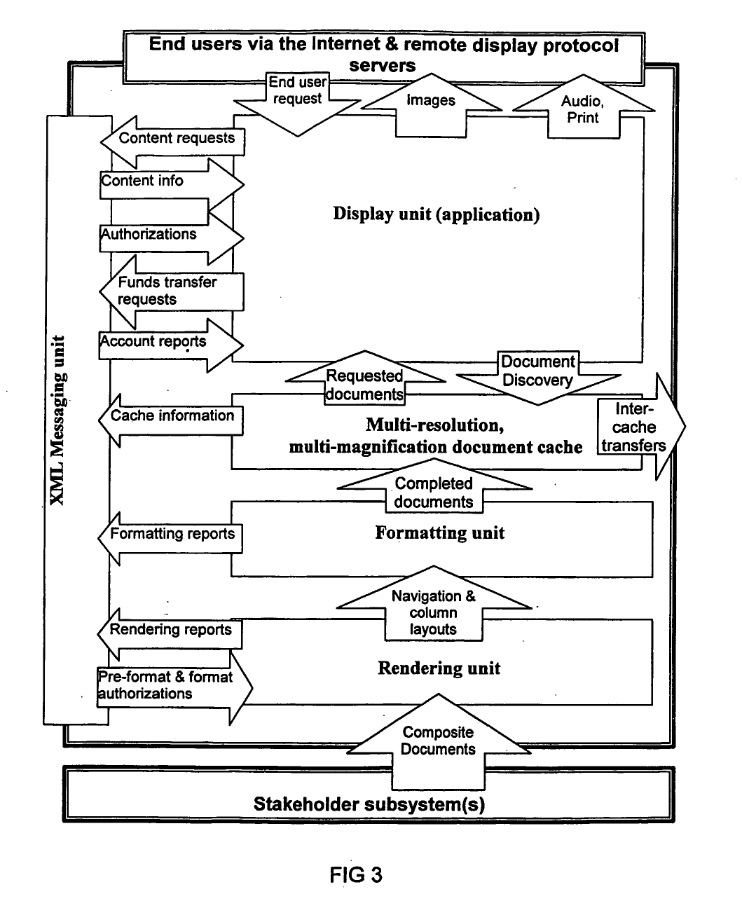

FIG. 4 is an overview of the stakeholder subsystem;

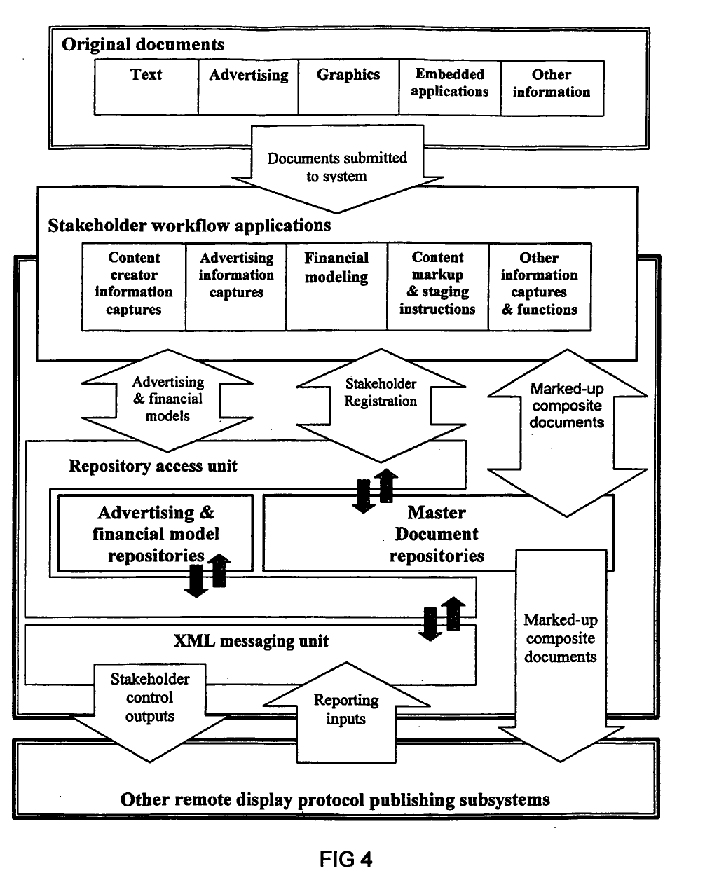

FIG. 5 is an overview of the web interface subsystem;

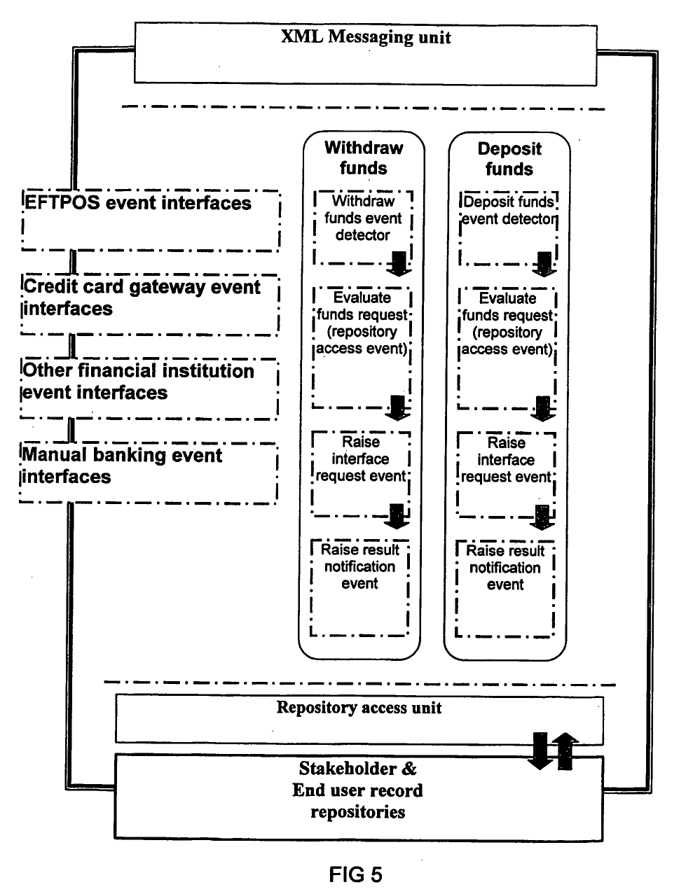

FIG. 6 is an overview of the payments subsystem;

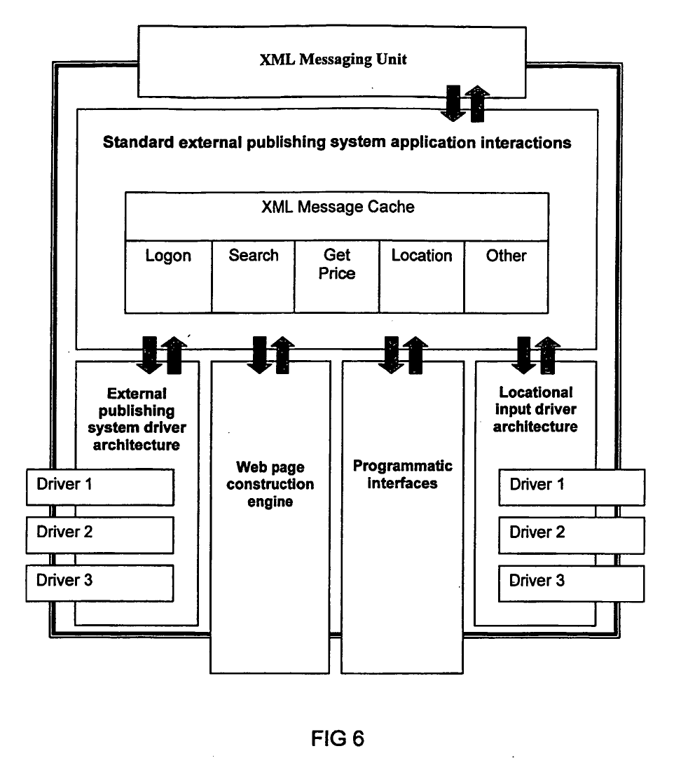

### DETAILED DESCRIPTION OF THE DRAWINGS

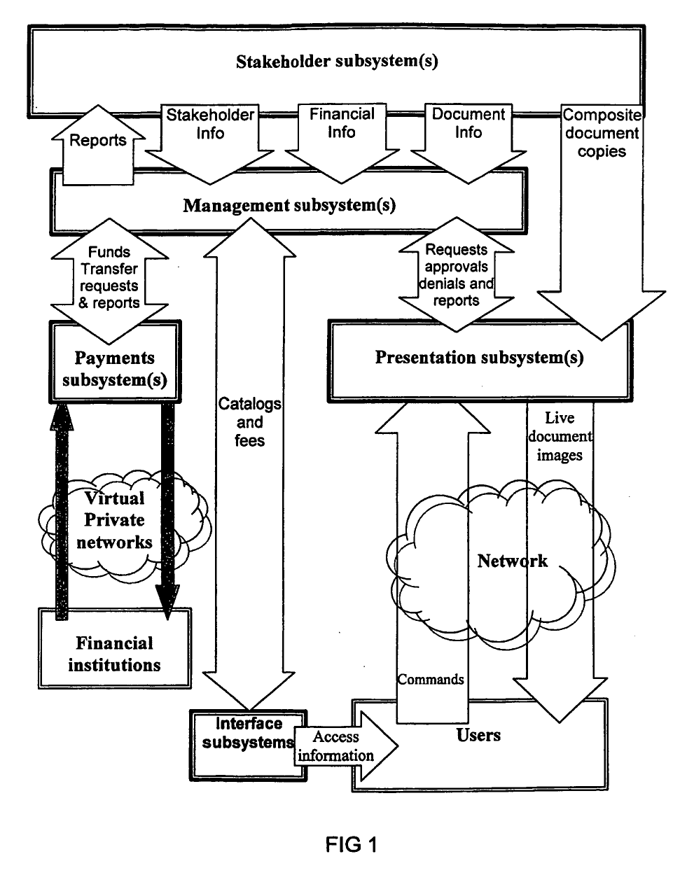

Referring to FIG. 1, there is shown an overview of the system for secure distribution of electronic documents and for collection of fees paid for content access. The system consists of two core subsystems and three supporting subsystems. For ease of explanation, the invention is described in terms of electronic documents but it will be appreciated that it includes any form of electronic content.

The core subsystems are a management subsystem, and a presentation subsystem. These core subsystems are supported by a stakeholder subsystem, a payments subsystem, and an interface subsystem.

The Management subsystem integrates the operation of the other subsystems and manages access to the content. It also enforces the manner in which content may be used.

The Presentation subsystem handles the rendering and reformatting of documents suitable for transmission via remote display protocols. It also handles imaging and navigation. This is done under the supervision and control of the management subsystem. There may be multiple presentation subsystems distributed across multiple servers.

Stakeholder subsystems allow preparation and publisher control of content by stakeholders for display by the presentation subsystems. Content may include text documents, images, advertising, applets or other material. The stakeholder subsystem also associates business models (financial models and other information pertaining to the use and effect of a document). A Stakeholder subsystems also store master copies of a publisher's documents (current and previous) plus provides staging and assembly areas for future publication.

The Payments subsystem handles all aspects of payment for viewing of content, including interfacing with financial institutions or other organisations for payment clearance. The subsystem deducts and makes payments under the control of the management subsystem.

The Interface subsystem provides hyperlinks, prices, authentication and other information to Web pages, the Presentation subsystem and other information viewing systems, such as WAP servers. This enables content imaged by the invention to be advertised online.

The current embodiment of these subsystems may be used in the following publishing scenario:
1. Application service providers (ASPs) load the interface and presentation subsystems on their computer(s), connecting them to the management subsystem via virtual private network(s);
2. Stakeholders such as publishers, content creators, advertising executives, advertisers and developers use the stakeholder subsystem(s) to put their documents on a server, attaching pricing models etc to them plus their release dates and staging instructions etc;
3. Publishers (or other stakeholders under certain circumstances) use the stakeholder subsystem(s) to nominate the ASPs they wish to image their content for them or let the management subsystem allocate these automatically;
4. The interface subsystems advertise documents or associated groups of documents by providing URLs (or other content pointers) and pricing information to publisher web sites etc;
5. Users click on advertised URLs, initiating an authentication session via the interface subsystems;
6. After authentication, the management subsystems assess the users right and financial standing to see the desired document image in relation to any associated business models;
7. If the user has the required access rights and funds on hand, the presentation subsystem is made available to display the required document image, if not, the user is lead through the process of gaining access rights if so allowed by the associated business models and supplying the required funds through the payment subsystems;
8. The presentation subsystem presents the requested document or choice of document within a group of documents according to the conditions set by the stakeholders and as enforced by the management subsystem;
9. As the image of a chosen document is being successfully presented, accounts within the management subsystem are being credited and deducted accordingly;
10. The presentation subsystem allows the User to search and navigate within a document and over the publisher's document image site or over multiple sites;
11. The presentation subsystem informs the management subsystem of document usage details, including advertising exposures etc;
12. Users may search and view other document images as access rights and funds allow, being diverted to the appropriate areas if these are deficient;
13. The management subsystem splits the revenues and expenses between all the stakeholders according to the advertising and financial models and which stakeholder originated each document accessed;
14. Payments/deductions are periodically settled with each of the stakeholders using the payments subsystem.

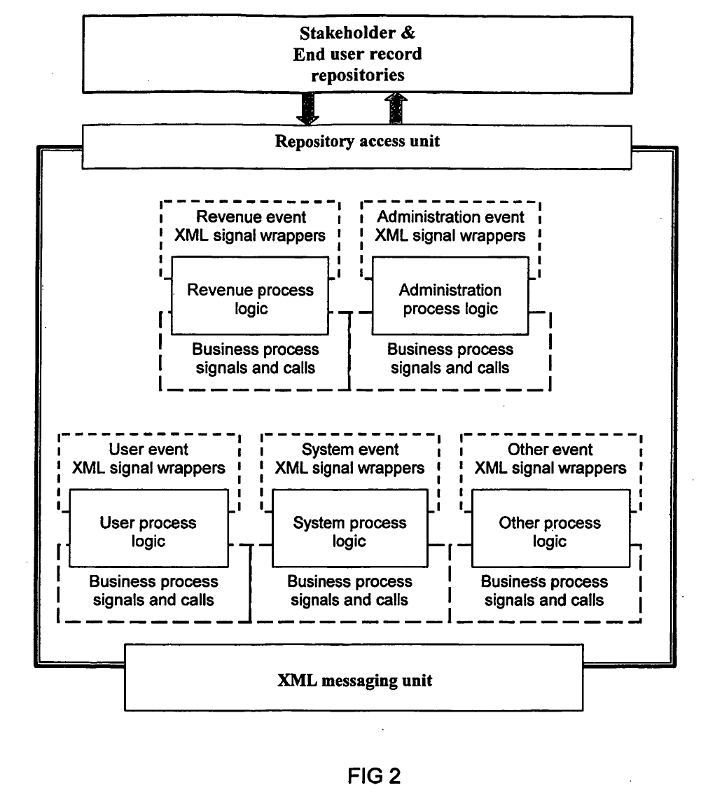

Looking at each subsystem in detail, FIG. 2 shows an overview of the management subsystem.

Management Subsystem

The management subsystem consists of four key physical and logical elements—files, processes, signals, and extracts.

Files contain encrypted cookies of information, using a position in a directory hierarchy to reflect the context in which the information was generated.

Processes act to summarise these files into meaningful reports, transferring them into compressed archives to save on disk space. These summaries may be presented to end-users in tabular form, suitable for use by a spreadsheet or database program. Processes may be triggered at set times or upon request, depending on the volume of files being handled and the timeliness of the information required.

Signals are files used to communicate messages or pass information between processes. The transmission of signals is the responsibility of the messaging units. Ultimately, most signals will become files. For example, a signal sent by the presentation subsystem to the management subsystem may be unpacked and stored by the latter in a number of relevant directory hierarchies. Therefore signalling is also a bandwidth reduction mechanism, as one signal from a presentation subsystem may cause many reads or writes in the file hierarchies maintained by the Management system. Copies of selected reports, files or archived files may then be aggregated into extracts, to be captured by database applications for detailed off-line analysis.

XML files and messaging units are used throughout the figures and description by way of example only. The system is not limited solely to XML.

Because this subsystem must eventually scale to handle millions of simultaneous users accessing millions of documents, information must be stored in a way closely resembling its intended use. In this way, processing will be reduced, saving money and increasing performance. Therefore the same information will often be stored in different ways. This also allows verification by crosschecking plus application-level data redundancy, enabling robust disaster recovery, even from damaged backup media.

In order to support the most common information requests, files are stored in directory hierarchies, which closely reflect their use by particular cohorts of users. Therefore, upon document presentation to the reader, the Management subsystem may employ the following set of hierarchical file stores:

1. Document usage record: A hierarchy reflecting the frequencies by which documents have been used over time, the top two directory levels for example being publisher and publication, the next being based on the document names and paths, then year-month, date and hour directories. An example directory path would be \\Log-Server\Frequency-Logs\Poplular Publishing\Daily Times\Front Page\First Story\2001-05\07\09. This represents how often the first story located on the front page of Popular Publishing's Daily Times, was viewed from 9 to 10 AM on the 7th of May 2001. This hierarchy also contains financial models generated by stakeholder applications.

2. Documents by authors: A hierarchy indicating the popularity of Authors pertaining to the use of documents, the top two directory levels for example being publisher and author, the next being based on the publication, document names and paths, then year-month and date directories. An example directory path would be \\Log-Server\Author-Logs\Poplular Publishing\Bill.Smith@isp.com\Daily Times\Front Page\First Story\2001-05\07. This represents the use of Bill Smith's article appearing on the front page of Popular Publishing's Daily Times, on the 7th of May 2001.

3. Reader record: A hierarchy indicating the use of documents by readers, the top two directory levels for example being based on the reader, year-month, then publication. An example directory path would be \\Log-Server\Reader-Logs\Fred.Jones@isp.com\2001-05\07\Daily Times\. This represents Fred Jones' use of the Daily Times, on the 7th of May 2001.

4. Document by reader: A hierarchy indicating reader document accesses rights. The top two directory levels for example are reader and publisher, the next based on the publication, document names and paths. An example directory path would be \\Log-Server\Author-Logs\Fred.Jones@isp.com\Poplular Publishing\Daily Times\Front Page\First Story\. This represents Fred Jones right to review an article appearing on the front page of Popular Publishing's Daily Times, on the 7th of May 2001.

5. Document to link: A hierarchy indicating which documents had hyperlinks clicked within them, the top two directory levels for example being publisher and publication, the next being based on the document names and paths, then year-month and date directories. An example directory path would be \\Log-Server\To-Link-Logs\Poplular Publishing\Daily Times\Front Page\First Story\2001-05\07. This represents the hyperlinks clicked in the first story located on the front page of Popular Publishing's Daily Times, on the 7th of May 2001.

6. Document from link: A hierarchy indicating how users reached particular documents, the top two directory levels being for example publisher and publication, the next being based on the document names and paths, then year-month and date directories. An example directory path would be \\Log-Server\From-Link-Logs\Poplular Publishing\Daily Times\Front Page\First Story\2001-05\07. This represents the hyperlinks clicked in the first story located on the front page of Popular Publishing's Daily Times, on the 7th of May 2001.

7. Advertising record: A hierarchy based on where and when advertising appeared, the top two directory levels for example being publisher and publication, the next being advertiser, then advertisement, year-month and date directories. An example directory path would be \\Log-Server\Advertiser-Logs\Poplular Publishing\Daily Times\Mighty Marketing\Better Mouse Trap\2001-05\07. This represents the display of Mighty Marketing's Better Mouse Trap ad on the 7th of May, 2001 to readers of Popular Publishing's Daily Times.

8. Documents by Advertising Executive: A hierarchy indicating the viewing of advertising in relation to their account managers, the top two directory levels for example being publisher and executive, the next being based on the publication, advertiser, advertisement, next, year-month and date directories then document names and paths. An example directory path would be \\Log-Server\Ad-Executive-Logs\Poplular Publishing\David.Brown@isp.com\Mighty Marketing\Better Mouse Trap\2001-05\07\Daily Times\Front Page\First Story\. This represents David Brown's sales of Mouse Trap ads appearing on the front page of Popular Publishing's Daily Times, on the 7th of May 2001.

9. Document by resolution: A hierarchy based on screen sizes and viewing distances, the top two directory levels for example being publisher and publication, the next being screen size, then zoom level, year-month and date directories. An example directory path would be: \\Log-Server\Resolution-Logs\Poplular Publishing\Daily Times\1 024×768\120\2001-05\07. This represents the use of 1024×768 pixel sized screens at a zoom level of 120 percent on the 7th of May, 2001 by readers of Popular Publishing's Daily Times.

10. ASP server usage: A hierarchy based on Application service providers and their servers, with the top two directory levels for example being ASP and server, then year-month, date and hour directories. An example directory path would be \\Log-Server\ASP-Logs\Reliable ASP\Production Server 2\2001-05\07\09. This represents how Reliable ASP's number two server was utilised from 9 to 10 AM on the 7th of May 2001.

11. Document by IP address: A hierarchy based on IP addresses, with the top two directory levels for example being publisher and publication, the next four consisting of octet numbers of the IP address range. Below that the structure shall be made up of year-month and date directories. An example directory path would be: \\Log-Server\IP-Logs\Poplular Publishing\Daily Times\203\036\032\102\2001-05\07. This represents the use of IP address 203.36.32.102 on the 7th of May, 2001 by readers of Popular Publishing's Daily Times.

12. Document by Error: A hierarchy based on documents which have generated errors, the top three directory levels for example being year-month, date and hour, then publisher and publication, the next being based on the document names and paths, then ASP and Server directories. An example directory path would be \\Log-Server\Error-Logs\2001-05\07\09\Poplular Publishing\Daily Times\Front Page\First Story\Reliable ASP\Server 2. This represents the error recorded in the first story located on the front page of Popular Publishing's Daily Times, on the 7th of May 2001, between 9 and 10 AM, running on Reliable ASP's number two server.

13. Document by Revenue: A hierarchy based on documents recording revenue generation, the top two directory levels for example being publisher and publication, then document names and paths, the next being based on the year-month, date and hour, then ASP and Server directories. An example directory path would be \\Log-Server\Revenue-Logs\Poplular Publishing\Daily Times\Front Page\First Story\2001-\05\07\09\Reliable ASP\Server 2. This represents the revenue made from the first story located on the front page of Popular Publishing's Daily Times, on the 7th of May 2001, between 9 and 10 AM, running on Reliable ASP's number two server. This hierarchy may also be used to calculate frequent reader points.

14. User funds: A hierarchy based on the funds available in user accounts, the top directory level being for example user ID or the publishers user ID, then two sub directories at the same level—cleared funds and uncleared funds, then three sub-directories at the same level, FundsIn, FundsOut, FundsAdjust. An example directory path would be \\Log-Server\Funds-Logs\EricWilson\ClearedFunds\FundsIn. This represents the funds deposited by Eric Wilson that have been cleared of the possibility of credit card fraud or cheque dishonour. Being a user rather than a publisher's user identifies that the funds belong to a universal subscription, not an individual publisher.

15. Entity Lookup codes: A hierarchy of entities and their codes. These codes shall be used to abbreviate filepaths so descriptions exceeding Windows 256 character limit can be accommodated. For speed, such lookups do not contain files, only directory names, and the last directory of the structure represents the desired code.

In one embodiment there are four classes of processes to be supported by the Management subsystem. These are revenue, user, administration and system. All of these processes store their information in the hierarchies described above. The following tables detail process names, functions and characteristics:

REVENUE PROCESSES

| Name | Function | Characteristics |
|---|---|---|
| Check access | Make sure user, | Checks Document by |
| | publisher, ASP is not | reader hierarchy for any |
| | restricted/suspended | problems in allowing users |
| | | to see the contents of a |
| | | folder |
| Get price | Determines if the | Uses the viewing block |
| | requested document is | hierarchy to check. Prices |
| | chargeable and for how | documents in relation to |
| | much or can be | who is asking for the price |
| | reviewed free of charge | (i.e. normal and discount |
| | | user groups) |
| Allocate funds | Reserves subscription | Reservation system allows |
| | moneys or viewing | multiple users of the one |
| | blocks for a requested | account plus documents |
| | document or service | are only charged when |
| | | successfully transmitted |
| Open document | Triggers a check access, | Allows Knowledge |
| | get price, and allocate | publisher to open a |
| | funds to allow a | document. Once Opened, a |
| | document to be opened | Document Sold function is |
| | | sent to make the charge |
| | | permanent. |
| De-allocate funds | Un-reserves subscription | If a document fails to load |
| | moneys or viewing | properly, free the reserved |
| | blocks for a requested | funds for another document |
| | document or service | choice |
| Document sold | Deducts viewing blocks | Also triggers document |
| | or funds | view system process to |
| | | update various hierarchies |

USER PROCESSES

| Name | Function | Characteristics |
|---|---|---|
| Subscribe | Adds subscription | This is where a user first |
| | details | ‘joins’ |
| | | CashForContent.Com |
| Recharge account | Processes credit card | Via credit card COM object. |
| | details and amounts | Must also gracefully handle |
| | | rejected requests etc. |
| Change details | Changes subscription | Allows end-users to alter |
| | details | contact details stored in |
| | | reader records hierarchy |
| View account | Allows user to see past | (Stored in Reader Records |
| | transactions and | hierarchy) |
| | account balances | |

ADMINISTRATIVE PROCESSES

| Name | Function | Characteristics |
|---|---|---|
| Credit funds | Add money to a user's | This is used to adjust |
| | account | balances for promotions etc |
| Debit funds | Deduct money from a | This is used to transfer |
| | user's account | funds between accounts etc |
| Credit viewing | Add viewing blocks to a | This is used to adjust |
| blocks | document for a user | balances for promotions etc |
| Debit viewing | Deduct viewing blocks | This is used to transfer |
| blocks | from a document for a | viewing blocks between |
| | user | accounts etc |
| Refund card | Send unspent funds to | Less handling fee in most |
| | credit card | cases, via credit card COM |
| | | object. |
| Suspend | Stops a document from | This is used to ‘turn off’ a |
| document | being approved for all | troublesome document |
| | users by the billing | |
| | system | |
| Suspend | Stops all documents in a | This is used to ‘turn off’ a |
| publication | publication from being | publication |
| | approved by the billing | |
| | system | |
| Restrict user | Restricts users to and | Allows businesses to |
| access | from certain | control where employees |
| | publications/documents | go, blocks porn etc |
| Suspend user | Suspends all user | ‘Turn off’ a user, user can't |
| | requests | recharge account |
| Suspend server | Denies a document | Used to block access to a |
| | access based on the | server causing problems |
| | server | |
| Suspend ASP | Denies a document | Used to block access to |
| | access based on the | ASPs causing problems |
| | ASP | |

SYSTEM PROCESSES

| Name | Function | Characteristics |
|---|---|---|
| Clear funds | Analyses the financial | Part of the risk analysis unit |
| | hierarchies to see what | |
| | funds can be moved | |
| | from pending to cleared | |
| | status | |
| Daily updates | Summarises daily | Based on date directories in |
| | updates into weekly and | various hierarchies. |
| | monthly reports. | |
| Monthly updates | Summaries weekly and | Based on month directories |
| | monthly reports. | in various hierarchies. |
| | | Transfers ‘daily’ directories |
| | | to compressed archive. |
| Quarterly and | Summaries monthly | Based on monthly reports |
| yearly updates | updates in year to date | Transfers ‘monthly’ |
| | and quarterly updates | directories to compressed |
| | | archive. |
| Full backup & | Backs up and restores | Backup device must not |
| Restore | archives | interrupt any other process |
| | | or function |
| Error log | Watches for critical | Automatically raises alerts |
| monitoring | errors | using email etc |
| RequestInfo | Gets system information | Used to check the status of |
| | about components | services |
| Halt process | Terminates a process | Used when services are |
| | abruptly | misbehaving. Current |
| | | process is instantly |
| | | destroyed. |
| Shutdown process | Gracefully closes a | Allows current activities to |
| | process at its earliest | complete before terminating |
| | possible convenience | |
| Clear queue | Destroys all XML | Used when resetting |
| | documents in a | processes |
| | nominated queue | |

A viewing block is a particular implementation of a financial model, which includes a combination of time and document session access charges. Such viewing blocks may also span multiple documents or sites.

Storage of the XML hierarchies may take place on a tier of servers, used exclusively for file services, collectively known as repositories. Encrypted control and financial signals transmitted by XML messaging units take place over virtual private networks which themselves are encrypted. One of these communications may contain a signal set, but even if it only consists of one signal, such a communication is known as an operation. Every operation is assigned a unique number for auditing and control purposes, generated by the sending XML messaging unit. This forms the main part of the encrypted-XML file's name and also appears within the file, making any attempt to change an operation number while in transit easy to detect.

Operation numbers consists of an operation type code, an ASP ID, server ID, session ID and timestamp combined with a sequence number. The operation type code allows receiving components to take basic actions with the encrypted-XML file without having to open it.

The sequence number is used to differentiate operation numbers on systems capable of forming multiple signals within a single unit of their system clock's time. Therefore a timestamp of 2001081000000000020 indicates the 20^{th} signal issued at exactly midnight (to the millisecond) on Aug. 10, 2001.

Thus, a properly formed operation number will look like this:
DocInfoReq.CFC.10001.10FC23.2001081000000000020.

Operation numbers allow the tracking of requests in relation to processes. For example, an operation to extract all customer details may be disallowed, even for a user with high enough raw data access privileges, on the grounds the signals within the operation do not constitute a legal process. That is, all operations must match at least one set of predetermined signals and be executed within an acceptable timeframe. All attempted illegal operations are duly logged.

A group of like signals may be sent in one encrypted XML message as a signal batch. Whether sent individually or in a batch, every encrypted XML message has an operation number.

The display units interacting with end-users are hardened against denial of service attacks. This is implemented by monitoring end-user activity, limiting the number of repeat operations for which no payment is required.

Most database, authentication and messaging mechanisms designed for corporate use (such as Microsoft's Active Directory, SQL Server and COM-Plus) do not perform well for more than 20,000 simultaneous users. A medium sized magazine, a typical publisher user, has 80,000 subscribers and there are around 144,000 magazines in the English-speaking world. The billing and tracking aspect of the management system must provide universal, publisher ‘stable’ and individual title subscription services for all of these. Therefore the Management and Stakeholder subsystems and messaging units are file-based for simplicity, with inbuilt load balancing mechanisms.

With information stored in a number of hierarchical file structures, the management subsystem repository naturally lends itself to partitioning between directories, volumes and servers. These hierarchies may also be further partitioned according to the logical groupings within them (alphabetically A-K and L-Z for example), as required. Thus load balancing can be achieved using simple partitioning techniques.

Presentation Subsystem

The Presentation subsystem operates in four stages under the control of the management subsystem. It consists of four units, for display, cache, formatting and rendering of documents:

1. Display Unit: This is responsible for maintaining the end user interaction and imaging documents for transmission using remote display protocols. The display unit also incorporates a number of features to detect misuse of the system.

2. Multi-resolution, multi-magnification document caches: Documents are fed from to display unit from the cache. This minimizes the need for processing by reusing previously formatted content. If a document is not available in the cache to suit the combination of the end-user's device, viewing distance and publisher and end user preferences, the formatting and rendering units are activated to provide one.

3. Formatting units: These minimize the need for end users to scroll though documents by dividing them into smaller, more manageable sections. These reformatted documents may or may not fit completely on the screen, depending on how the content has been marked up, the device size it's images are being viewed on plus publisher and end-user preferences. The reformatting process resizes and moves content to fit, as well as employing various ‘blank space’ reduction and insertion techniques. These include condensing text, reducing tab stops, adjusting margins etc. The basic layout of the document in which this is done is predetermined by a rendering unit.

4. Rendering units: By examining the dimensions of the available viewing area, the rendering unit analyses end-user and publisher preferences to determine a suitable document layout and navigation system. This basic layout is then used by the formatting unit to measure and manipulate content.

Information pertaining to end-user interactions, such as document navigation, is encrypted. This prevents unauthorized display units or external viewers from improperly accessing content. Documents may also be password protected to prevent opening by unauthorized display units or viewers.

Using the current embodiment of the invention, the presentation subsystem may be used in a commercial publishing environment in the following manner:
1. Presentation subsystems are loaded on Application Service Provider machines;
2. Publishers allow their content to be connected to Application Service Providers running the Presentation Subsystems;
3. Stakeholder subsystems provide information to the interface subsystems, allowing links to the presentation subsystems to be published in Web pages or other browser display protocols such as WAP;
4. An end-user requests to see a document by clicking on a link;
5. The interface subsystems forward locational information to the management subsystems;
6. A logon session is created (such as via a secure Web page or remote display protocols) to find out who the user is in relation to the publisher, which if successful, causes the management subsystem to create a unique session number for that user's session with the presentation subsystem;
7. The logon session forwards locational information to the Management subsystem;
8. The display unit forwards locational information to the Management subsystems;
9. The display unit finds the document in the Cache unit;
10. The caching unit may attempt to obtain the document from another's Presentation subsystem's cache
11. If the document is not in or found by the cache, the display unit obtains the document's location from the Management sub-system, allowing it to draw on the publisher's master document repository. If the Management Subsystem is not aware of the document's location, the display unit forwards a request to the management subsystem to issue a new document ID to the document, which in most cases becomes its filename and path; the location of this newly named document is then sent back to the Presentation Subsystem;
12. Once the desired document's filename has been established, the management subsystem evaluates the request, authorizing it according to the business models associated with the document;
13. Once authorized by the management subsystem, the display unit seeks a document from the cache corresponding or suitably sized to the display area, user and publisher preferences. If one can be found (the majority of cases), it is loaded and displayed for image transmission, if not, the rendering unit is engaged to determine an appropriate layout and navigation system and the reformatting unit then handles the content accordingly;
14. The caching unit may attempt to obtain a suitable document from another's Presentation subsystem's cache, rather than initiate fresh reformatting.
15. After being loaded from the cache, the document image is displayed via remote display protocols;
16. The display unit accepts navigation commands from the user;
17. The display unit monitors end-user activity in relation to time or session charges as controlled by the management subsystem;
18. The display unit monitors ‘revenue content’ such as advertising, informing the management subsystem of its exposure;
19. The display unit also provides account management tools and activity reports to end users;
20. The display unit also provides end-users integrated searching between sites, documents and the content within a document;
21. The display unit also provides histories of previously seen documents, favorites and ‘to-do’ lists of must-see documents;
22. The display unit also embodies the functions of the interface subsystems, allowing further content to be viewed without leaving the remote display protocol environment.
23. From time to time, the caching unit may delete from itself infrequently used documents. Conversely, it may be pre-loaded with previously formatted documents in anticipation of heavy use. This may be implemented under Management system control according to the business models associated with a document.

The above scenario would not contain as many steps if the invention is used to display documents on an end-user's machine to their cell phone over the Internet. Organisations running the publishing system in-house may also require fewer steps. Depending upon the implementation, the order of steps may also vary. However in all cases, the unique four-stage architecture of the presentation subsystems remain the same.

It will be appreciated that the presentation subsystem, and in particular the display unit, is not limited to on-screen display. For example, content may be sent directly to a commercial printer for one-time hard copy printing, to a sound studio for one-time listening, or to a cinema for viewing. In all cases, a ‘screen’ also may be understood as the display area in which a document is to be imaged, such as within a box on a Web page.

Cache, rendering, reformatting and display units may be distributed across one or more machines for load balancing and performance optimization.

Stakeholder Subsystems

The stakeholder subsystems provide management functions for authors, publishers, advertisers advertising executives, editors, developers, the invention's operators or any other party with an interest in content. They comprise a set of workflow applications linked to document and information repositories. These are linked via virtual private networks and an XML messaging unit to the invention's other subsystems. In the preferred embodiment of this invention these repositories are comprised of file system hierarchies, although they well could be other stores such as relational databases.

The stakeholder workflow applications comprise of:

1. Stakeholder information captures: These associate information such as Title, Author, Summary and Business Model indicators to documents. By noting these indicators, the management subsystem is able to determine the way a document should be treated, by consulting the business models to which the indicators refer.

2. Advertising information captures: These allow advertising executives and creative staff to associate objects embedded within documents to an advertising model. An example of an advertising model could be to display a set of advertisements in random order as a page is accessed or change the advertisements if a user revisits a page, with the appropriate fees for each type of exposure.

3. Business modeling: These applications create a marketing structure around a collection of documents through associations with business models. A business model will typically contain pricing information to which documents refer via their indicators, as well as revenue and expense splitting ratios between stakeholders. A special kind of business model is an advertising model, embodying the terms and conditions of embedded content for automated billing and display.

4. Content markup and staging: These applications are used to govern the release of documents and information from the Stakeholder's master document and model repositories to the presentation, interface and management subsystems. This allows publishers to perform functions such as setting ‘opening dates’ on new parts of their site, managing the document update process or rolling back their sites to previous versions of documents.

5. Other information captures and functions: A number of other functions complete the stakeholder application suite. This includes reporting tools allowing all the stakeholders to review the progress of their interest in sites and documents.

Another major component of stakeholder subsystems are the advertising and business model repositories. These hierarchies of XML documents are referred to by indicators attached to documents. One document may be thus associated with many business models. When this happens, by default, the system will determine the cheapest option for the end-user or advertiser or offer them a choice of under which set of terms and conditions the document is to be made available.

Stakeholder master document repositories are file or document management systems where documents are stored and released to presentation subsystems via virtual private networks. They also form the staging area for future document releases plus an archive of past releases which have been withdrawn from circulation.

An XML messaging unit is provided to facilitate information transfers between stakeholder subsystems and the other subsystems.

The preferred embodiment of these subsystems could be used in the following scenario:
1. A publisher nominates an application service provider or elects to run a stakeholder application suite on their own systems;
2. The publisher registers the stakeholders to be recognized by the site;
3. Authors use the stakeholder application suite to stake their claim on a document via document indicators;
4. A publisher submits the document to the system, in so doing acknowledging the claims made by the author indicators;
5. Business model indicators are associated, recognizing the role of advertisers, editors, advertising executives, developers and others;
6. At any stage, documents may be marked up for manual optimization for image display using remote display protocols. For example, it might be necessary to stop image resizing where a picture's detail must be displayed, such as with a map;
7. At any stage, documents and their organisation within the repository may be marked up to control the timing of their release;
8. Document information is retrieved from the various repositories via XML Messaging units by the management subsystems;
9. Application service providers running interface subsystems also access repositories to display information in Web, WAP or pages described by other protocols or formats, for end-users not currently being handled by the presentation subsystems;
10. As requested by the user and allowed by the management subsystem, copies of documents are released from the stakeholder's master document repository to various presentation subsystems;
11. Reports are provided to stakeholder applications from the invention's other subsystems, for realtime management of documents, sites and stakeholder relationships;
12. All of the above functions are also designed to maintain their currency on an ongoing basis. For example, a document's author revenue shares may change over time as a document is updated by different people.

The stakeholder subsystem is designed to support rich collaboration between all the participants. Therefore stakeholder subsystems may be distributed across a large number of locations, while the management subsystems are designed to be centralized over a small number of locations. However there may also be a market for management subsystems to be deployed for private in-house use for secure publishing operations within organisations, such as armed forces.

Payments Subsystem

The Payments subsystem is the gateway by which transactions between financial institutions such as credit card companies or banks are conducted. Transactions with non-financial institutions which non-the-less manage funds, such as telecommunications carriers or utility companies, are also supported.

The Payments subsystem, working under the authorization of the Management subsystem, enables both deposits and withdrawals from accounts operated by all those associated with the use and operation of the system. This facilitates both content end-user payments and refunds plus monetary transfers to and from stakeholders, including authors and advertisers. It communicates to the Management subsystem the success, failure and nature of payments. It is also used for the updating of account balances, risk analysis and other purposes.

The Payments subsystem also has human interfaces for manual transaction entry, such as for cash or checks.

Interface Subsystem

The job of the Interface subsystem is to enable interaction between the system's secure publishing environment and other publishing systems.

This is often necessary because publishing document images using remote display protocols is orders of magnitude more expensive to set up and run than traditional online publishing systems. This is because the entire end-user experience must be supported by the publishing system rather than simply sending off a few files for a browser to interpret and render. This means information which cannot be sold, such as a catalogue of documents for sale, will most likely be presented using cheaper Web-based protocols such as HTML and Java-Script.

Another scenario is where the publisher chooses to accept the risk of allowing readers to download encrypted content for offline use (such as large tables or diagrams), by employing an alternative publishing system. In this case the management subsystem may need to inform such document download software of details concerning both the document and the reader.

To support business models such as these, an Interface subsystem is required to supply information stored in the management subsystem to other publishing systems. Functions of the Interface Subsystem are also included in the Presentation subsystem, allowing document browsing, searching and pricing information to be accessed from within the system. Once a user is interacting with the Presentation subsystem there is no need to leave it to make another purchase. This convenience aside, the ability to access the Interface subsystem from within the invention allows catalogs of content for sale to be displayed on devices which cannot easily render Web pages, such as small-screen mobile devices.

The operation of the Interface subsystem therefore depends on the kind of publishing system requiring management system support. An-end user may wish to access a conventional web page of a publisher to browse a catalog of content available through the invention. In this case, the Interface subsystem will provide the publisher's Web server with such information as a full hierarchical or list view of the content available on a site, or a search result subset of this. Pricing, conditions, summary and other information may also be supplied, according to stakeholder business models.

In order to apply business models to obtain the correct price for a particular end user, the Interface subsystem may also ask for or accept an end-user login. If no end-user login is supplied, anonymous user prices and conditions or no prices and conditions will be supplied, depending on the business model(s) associated with the document.

Information shared between Stakeholder, Management and Interface subsystems is likely to be repetitious. In order to minimize the use of network resources and speed response times, a caching mechanism for these common signals may be employed.

The Interface subsystem has the capability to generate Web pages for transmission by a Web server. Alternatively, publishers can design their own Web pages that programmatically insert the desired information drawn from the Interface subsystem. Another method is to insert an applet into a Web page or use stand-alone programs, which communicate with the Interface subsystem in real-time, enabling a more dynamic display of its information.

To support more complex interactions, such as the issuing of instructions to another publishing system to send or allow content to be downloaded, a driver architecture is employed to suit the interfaces provided by the alternate publishing system.

A preferred embodiment is to have at least one interface subsystem on each alternate publishing system, connected to the management system via a virtual private network. The preferred embodiment for the Interface subsystem implicit to the Presentation subsystem is to implement one per user session.

The Interface subsystem is also capable of obtaining locational information from end-users, in order to restrict the content catalog in legal jurisdictions which may be offended by the material. Acquired locational information may also be used to determine content offerings pertinent to the end-user's locale. Information on the end-user's whereabouts may be supplied to the Interface subsystem from a mobile device, Internet/Application service provider, telecommunications carrier or other hardware, software or other location-knowing entity. End-user location details may also be approximated using information supplied by the networks through which end users are connected.

A particular embodiment of an Interface subsystem may support different levels of the functionality described. For example, in a mobile device such as a cell phone, a connection from the Management system to a carrier's own billing system may imply a logon, by virtue of possession of the phone connected to the network. In this case, the Interface subsystem provided to the carrier's WAP gateway would not necessarily need to provide a separate login function. On the other hand, for privacy or security reasons, some locational functions may be omitted in Interface subsystems deployed in some places or disabled when the system is accessed by ‘location sensitive’ persons.

Security

The division of the invention into various subsystems lends itself to the creation of security zones, safeguarding the privacy and integrity of information stored by the system. The preferred embodiment operates within (but is not limited to) six general security zones:
1. End users interacting using Web pages through the Interface Subsystem are considered to be in the un-trusted Internet zone.
2. End users accessing live content images using the Presentation subsystem located at an Application service provider are considered to be in the end-user zone. They typically access the invention through a remote display protocol or other login using a guest account through tightly controlled TCP/IP ports.
3. The publisher-zone is where interpreted document macros, screened for suspicious looking or possibly dangerous system calls, may execute. Authorised, embedded or linked applications, including embedded remote display protocol sessions, also fall within this zone.
4. The ASP (Application Service Provider) zone is where the Presentation and Interface subsystems typically run. This is a semi-trusted environment, where information and instructions are conveyed to and from the management system through encrypted-file transfers via virtual private networks operating through tightly controlled TCP/IP ports.
5. The fifth zone is the management zone, where records are kept and maintenance functions are performed.
6. The administrative zone is for the invention's operators, allowing them access to customer account and reporting information.

Because the bulk of the invention's communications and storage is file-based, access between zones may be enforced using standard operating system security mechanisms. Monitoring the information flows themselves for legitimate use enhances the zone-based access controls.

To prevent the management system from being bypassed, business logic concerning the eligibility to view documents is typically compiled into the Presentation subsystem. In order to prevent tampering of end user accounts, business logic executing financial transactions is preferably located on Management subsystem servers, behind the system operator's firewalls.

Storage takes place on a third tier of Management subsystem servers, used exclusively for file services. Thus Presentation subsystems located on service provider machines never have direct access to the encrypted files located in hierarchical data structures, which are given the strictest access controls. All correspondence between storage repositories and users of their information takes place using signals from duly authorised management and stakeholder processes, never directly from the Presentation subsystems.

Signals between all subsystems are conducted using encrypted files. This communication typically takes place over virtual private networks which themselves are encrypted.

The invention provides a system of modifying, distributing and accounting for live document images, made suitable for transmission via remote display protocols through automated reformatting of source documents, with limited selection and copying of text or graphics for publisher copyright control. It enables higher value content to be sold online, plus enhances the end-user experience, making document images more readable when viewed in a live application (not downloaded like the Web's HTML) over slow networks. Document production costs are also reduced with single-document publishing, utilizing reformatting engine(s) to handle the complexity of suitably resizing content for most devices. The system and method also secures documents for e-commerce by only allowing their images to be viewed. The viewed documents are easily read over the Internet via remote display protocols and navigated by users from their PCs, servers, or various mobile devices.

Documents are made available to the invention for reformatting, to suit a combination of varying remote display protocol environments, screen sizes, viewing distances, plus end-user and publisher preferences. Copyright protection is achieved by only sending live images of these documents via remote display protocols, both modifying the original content for easy navigation on the display device while disabling its reproductive capabilities. Live image transmission only occurs after the management subsystem has authorized such end-user requests. The task of billing and tracking and reformatting documents for better remote display protocol transmission is split between two types of computing infrastructures: One serves the management subsystem and maintains unified control while the other widely distributes the presentation subsystem for image processing between machines, thus the invention can securely enable millions of simultaneous live document image users.

The system is designed to thus sell reformatted document images, or subscriptions to them, from single or multiple publishers to single or multiple users, or to distribute document images free of charge to end-users with their reformatting, distribution and tracking paid for by third parties. The system is also able to automatically split revenues and expenses generated by the documents, between all of a document's relevant stakeholders (authors, editors, publishers, ISPs, etc) made known to the system.

Of greatest value to publishers is the system's support for copyright protection (resistance to wholesale reproduction). Only being sent the live image of a document, not the document itself, means the receiver is prevented by the system from selecting the text to copy unless the management system allows it, plus the user never gets the formatting tags, navigational links or source code required to redistribute documents intact for viewing on another system. As with paper, all the user can access is an image of the final document, not the original artwork from which it was created. However awkward and un-navigable screen dumps are possible, which is considered fair use of the material, similar in principle to photocopying portions of paper-based documents.

The system displays documents on small-screen devices with high fidelity, having reformatted them accordingly for a much improved user experience. Having an image maintained on a server and only displayed on user machines also provides publishers with total font control. They can even publish the live image of applets within documents. Because they are live images within a live image, these applets need no downloading or installation and therefore are not subject to the unexpected problems Java or Java-Script applets sometimes cause.

For publishers, the reformatting function of the presentation subsystem avoids many of the costs currently associated with Web development. For example, one document can be displayed on any sized device, big or small, whereas often Web pages have to be completely redesigned for this purpose. By using remote display protocols, no local content handling takes place on end-user machines, allowing the system to be usable with many more device types than just Web browsers, such as millions of DOS PCs in third-world countries or tens of millions of new mobile devices being sold in more developed countries.

The system attaches business model indicators to documents rather than pricelists, the business model determines how a document is charged for under different circumstances. The billing/tracking aspect of the management subsystem uses these business models, evaluating them against end-user records and their current status, thus determining the appropriate price. In this way publishers can implement a wide range of marketing options for their content, without having to pay for a custom-built billing and tracking system.

Finally, in relation to the Internet's rampant credit card fraud, the system reduces the risks for publishers in three ways, better supporting the added expense of document image publishing. Firstly, the billing/tracking aspect of the management subsystem has the capacity to distinguish ‘cleared funds’ from those where a dishonor from a bank or credit card company is still possible. Publishers can therefore adjust their business models accordingly, perhaps offering bonuses for the better payments. The system is also able to identify users with good track records, informing publishers of low risk users from records generated from their prior use across all publishers—without violating the end user's privacy. And the aggregation of transactions across multiple publishers can be leveraged to get a better deal from financial institutions.

Throughout the specification the aim has been to describe embodiments of the invention without limiting the invention to any specific combination of alternate features.

1. A system for secure distribution of electronic content comprising:
a management subsystem that checks business models associated with electronic content to determine viewing conditions and levying, collection and distribution of fees; and
one or more presentation subsystems that retrieve electronic content from one or more repositories, said presentation subsystems comprising:
one or more formatting units that divide the electronic content into manageable sections; and
one or more rendering units that analyse end-user and/or publisher preferences in conjunction with end-user display characteristics to determine suitable content navigation and content layout.

2. (canceled)

3. (canceled)

4. The system of claim 1 wherein the management subsystem further comprises:
files containing cookies of encrypted information, with filenames and paths reflecting the context in which the information was generated;
processes that summarize these files into reports;
signals to communicating these files as messages or passing them between processes; and
extracts being captured for detailed off-line analysis being aggregates of selected said reports, said files or archives of said files.

5. (canceled)

6. The system of claim 1 wherein the presentation subsystem further comprises:
a display unit that maintains the end user interaction and images documents for transmission using said remote display protocols; and
document caches that store previously rendered and reformatted electronic content;
formatting units that divide electronic content into manageable sections.

7. (canceled)

8. (canceled)

9. The system of claim 1 further comprising an interface subsystem that provides access for users to the electronic content and indicates any fees to be levied.

10. The system of claim 9 wherein the interface subsystem obtains location information about the user and restricts access to the electronic content according to legal restrictions of the location.

11. The system of claim 9 wherein the interface subsystem obtains location information about the user and determines content offerings pertinent to the location.

12. The system of claim 1 further comprising a payment subsystem that intermediates payments between fee payers, fee receivers and one or more financial institutions or organizations maintaining accounts on behalf of the fee payers and/or fee receivers.

13. (canceled)

14. (canceled)

15. The system of claim 1 further comprising one or more stakeholder subsystems that provide management functions for one or more of: authors, publishers, advertisers, developers, operators of the system and other stakeholders, said management functions including associating business models with electronic content.

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A system for secure distribution of electronic content comprising:
one or more presentation subsystems that retrieve electronic content from one or more repositories and render the electronic content for display by remote display protocols by determining suitable content navigation and content layout and automatically dividing the electronic content into manageable sections; and
a billing subsystem that levies fees for display of said electronic content.

30. (canceled)

31. The system of claim 29 wherein the billing subsystem includes means for tracking fees paid and distinguishing between fees paid with cleared funds from fees paid with uncleared funds.

32. (canceled)

33. (canceled)

34. (canceled)

35. (canceled)

36. (canceled)

37. (canceled)

38. The system of claim 29 wherein the repositories are multi-resolution, multi-user caches populated by documents: formatted to minimize scrolling; or suitable for end user, publisher and display device characteristics; created utilizing various rendering and formatting techniques.

39. (canceled)

40. (canceled)

41. (canceled)

42. The system of claim 29 further comprising an interface subsystem that obtains location information about the user and restricts access to the electronic content according to legal restrictions of the location.

43. The system of claim 29 further comprising an interface subsystem that obtains location information about the user and determines content offerings pertinent to the location.

44. A system for secure distribution of electronic content comprising:
a Management Subsystem for determining viewing conditions and levying, collecting and distributing fees;
one or more Presentation Subsystems that retrieve electronic content from repositories, comprising:
one or more Formatting Units to reformat the electronic content, minimizing the need for end-users to scroll through documents by dividing them into smaller more manageable sections and resizing or moving of content;
one or more Rendering Units examining dimensions of the available viewing area to determine suitable content layout and content navigation, also taking end-user and/or publisher preferences into account, by which the Formatting Units reformat content to suit the Rendering Units;
one or more Display Units maintaining end-user interaction with and display of the reformatted content.

45. The system of claim 44 where the Display Unit receives content images via remote display protocols.

46. (canceled).

47. (canceled)

48. (canceled)

49. (canceled)

50. The system of claim 44 wherein the management subsystem further comprises:
files containing cookies of encrypted information, with filenames and paths reflecting the context in which the information was generated;
processes that summarize these files into reports;
signals communicating these files as messages or passing them between processes; and
extracts captured for detailed off-line analysis being aggregates of selected reports, said files or archives of said files.

51. A system for the secure distribution of electronic content comprising:
a Management Subsystem that checks one or more business models associated with content, representing a plurality of stakeholder interests, to determine viewing conditions, the levying, collection and distribution of fees;
one or more Presentation Subsystems that retrieve electronic content from repositories and maintain end-user interaction and content display by automatically dividing the electronic content into manageable sections and determining suitable content navigation and content layout.

52. The system of claim 51 where business models are associated with documents via indicators.

53. The system of claim 51 where the Management Subsystem interfaces with one or more publishing systems which allow content to be downloaded to a Presentation Subsystem.

54. (canceled)

55. (canceled)

56. (canceled)

57. The system of claim 51 further comprising one or more stakeholder subsystems that provide management functions for one or more of: authors, publishers, advertisers, developers, operators of the system and other stakeholders; said management functions facilitating the mark-up of content with one or more stakeholder preferences relating to the automatic rendering, automatic formatting or managed display of content.

58. (canceled)

59. (canceled)

60. (canceled)

61. (canceled)
